(19) United States
(12) Patent Application Publication
(10) Pub. No.: US 2021/0287011 A1
(43) Pub. Date: Sep. 16, 2021

(54) INFORMATION INTERACTION METHOD AND APPARATUS, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Zhidong Lang, Beijing (CN); Junhui Wu, Beijing (CN)

(21) Appl. No.: 17/257,538

(22) PCT Filed: Sep. 17, 2019
(86) PCT No.: PCT/CN2019/106256

§ 371 Date: Dec. 31, 2020

(30) Foreign Application Priority Data
Nov. 30, 2018 (CN) 201811458640.1

(51) Int. Cl. G06K 9/00; H04N 21/2187; G06N 3/08; G06K 9/62; H04N 21/4788; H04N 21/4784; G06F 40/30

(52) U.S. Cl. CPC G06K 9/00758; H04N 21/2187; G06K 9/00744; G06F 40/30; G06K 9/6256; H04N 21/4788; H04N 21/4784; G06N 3/08

(57) ABSTRACT

Implementations of the present application provide an information interaction method and apparatus, an electronic device, and a storage medium. The method and apparatus are applied to a server in a network live broadcast system. The server is used to, in response to a command selection instruction from a first electronic device persistently connected to the server, push a command text indicated by the command selection instruction to a second electronic device persistently connected to the server, such that the second electronic device displays the command text; receive a movement video corresponding to the command text uploaded by the second electronic device; and if the movement video matches semantics of the command text, perform a preset matching operation.

The application claims the priority from P.C.T. Application No. PCT/CN2019/106256, filed Sep. 17, 2019, which claims priority from Chinese Patent Application No. 201811458640.1, filed with the Chinese Patent Office on Nov. 30, 2018, and entitled “INFORMATION INTERACTION METHOD AND APPARATUS, ELECTRONIC DEVICE, AND STORAGE MEDIUM”, each of which is hereby incorporated by reference in its entirety.

### TECHNICAL FIELD

The implementations of the application relate to the field of Internet technology, and in particular, to an information interaction method, apparatus, electronic device, and storage medium.

### BACKGROUND

In real-time interactive webcast systems, in most cases, there is only one host in a live streaming room, but there will be many audiences. Therefore, the webcast realizes an interactive communication scene with one-to-many communication as a main mode and host's video and audio expression as a center, and needs to ensure an equal relationship between the audiences. The inventor found that in the current process of mutual communication, there is a manner that the host user sends information prompt, so that the audience user provides corresponding result information according to the prompt information. When the result information matches a preset result, the audience user will be rewarded according to a preset rule. However, the program of this manner is fixed and cannot attract more users to participate, which lowers the effect of live steaming.

### SUMMARY

Implementations of the application aim to provide an information interaction method, apparatus, electronic device, and storage medium.

According to a first aspect, an implementation of this application discloses an information interaction method, including: pushing a command text indicated by a command selection instruction to a second electronic device persistently connected to a third electronic device in response to the command selection instruction of a first electronic device, such that the second electronic device displays the command text; receiving an action video corresponding to the command text uploaded by the second electronic device; and performing a preset matching operation when the action video matches semantics of the command text.

According to a second aspect, an implementation of this application discloses an information interaction apparatus, including: an instruction response module, configured to push a command text indicated by a command selection instruction to a second electronic device in response to the command selection instruction of a first electronic device, such that the second electronic device displays the command text; a video receiving module, configured to receive an action video corresponding to the command text uploaded by the second electronic device; and a first execution module, configured to perform a preset matching operation when the action video matches the command text.

According to a third aspect, an implementation of this application discloses an information interaction method, including: receiving and displaying a command text pushed by a first electronic device according to a command selection instruction; acquiring an action video corresponding to the command text; detecting whether the action video matches semantics of the command text; and performing a preset matching operation when the action video matches semantics of the command text.

According to a fourth aspect, an implementation of this application discloses an information interaction apparatus, including: an information receiving module, configured to receive and display a command text pushed by a first electronic device according to a command selection instruction; a video acquisition module, configured to acquire an action video corresponding to the command text; a second matching detection module, configured to detect whether the action video matches semantics of the command text; and a second execution module, configured to perform a preset matching operation when the action video matches semantics of the command text.

According to a fifth aspect, an implementation of this application discloses an electronic device, applied to a webcast system, including a processor and a memory for storing instructions executable by the processor. The processor is configured to: push a command text indicated by a command selection instruction to a second electronic device in response to the command selection instruction of a first electronic device, such that the second electronic device displays the command text; receive an action video corresponding to the command text uploaded by the second electronic device; and perform a preset matching operation when the action video matches semantics of the command text.

According to a sixth aspect, an implementation of this application discloses an electronic device, applied to a webcast system, including a processor and a memory for storing instructions executable by the processor. The processor is configured to: receive and display a command text pushed by a first electronic device according to a command selection instruction; acquire an action video corresponding to the command text; detect whether the action video matches semantics of the command text; and perform a preset matching operation when the action video matches semantics of the command text.

According to a seventh aspect, an implementation of this application discloses a non-transitory computer-readable storage medium. Instructions in the storage medium, when executed by a processor of a mobile terminal, cause the mobile terminal to execute the information interaction method according to the first or third aspect.

According to an eighth aspect, an implementation of this application discloses a computer program product, which causes an electronic device to execute the information interaction method according to the first or third aspect when executed by a processor of the electronic device.

The technical solutions provided by the implementations of the application may include following beneficial effects. Through the above operations, preset operations, such as rewards, can be performed on users in different situations, which can enrich the manners of information interaction, attracting more users to participate, and improving the live streaming effect.

### BRIEF DESCRIPTION OF THE DRAWINGS

FIG. 1 is a flow chart showing an information interaction method according to an example implementation;

FIG. 2 is a flowchart showing another information interaction method according to an example implementation;

FIG. 3 is a flowchart showing yet another information interaction method according to an example implementation;

FIG. 4 is a flowchart showing a matching detection method according to an example implementation;

FIG. 5 is a flow chart showing a model training method according to an example implementation;

FIG. 6 is a flowchart showing another information interaction method according to an example implementation;

FIG. 7a is a block diagram showing an information interaction apparatus according to an example implementation;

FIG. 7b is a block diagram showing another information interaction apparatus according to an example implementation;

FIG. 7c is a block diagram showing yet another information interaction apparatus according to an example implementation;

FIG. 8 is a block diagram showing another information interaction apparatus according to an example implementation;

FIG. 9 is a block diagram showing yet another information interaction apparatus according to an example implementation;

FIG. 10 is a block diagram showing yet another information interaction apparatus according to an example implementation;

FIG. 11 is a block diagram showing yet another information interaction apparatus according to an example implementation;

FIG. 12 is a flowchart showing yet another information interaction method according to an example implementation;

FIG. 13a is a flowchart showing yet another information interaction method according to an example implementation;

FIG. 13b is a flowchart showing yet another information interaction method according to an example implementation;

FIG. 13c is a flow chart showing another matching detection method according to an example implementation;

FIG. 14 is a block diagram showing yet another information interaction apparatus according to an example implementation;

FIG. 15a is a block diagram showing yet another information interaction apparatus according to an example implementation;

FIG. 15b is a block diagram showing yet another information interaction apparatus according to an example implementation;

FIG. 16 is a block diagram showing an electronic device according to an example implementation; and

FIG. 17 is a block diagram showing another electronic device according to an example implementation.

### DETAILED DESCRIPTION

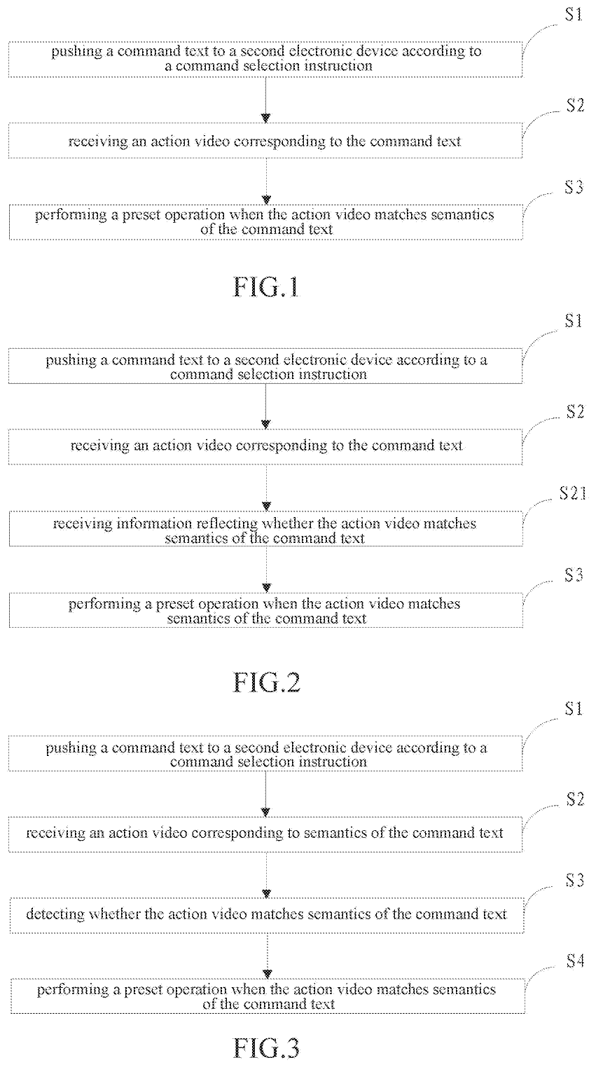

FIG. 1 is a flowchart of an information interaction method according to an example implementation. This information interaction method is applied to a third electronic device, which can be understood as a server of a webcast system. The information interaction method includes following operations.

S1, a command text is pushed to a second electronic device according to a command selection instruction.

The command selection instruction is sent from a first electronic device corresponding to the second electronic device. As for the webcast system, the first electronic device can be understood as an audience end that is persistently connected with a server, and the second electronic device is a host end that is persistently connection with the server and corresponds to the audience end. In response to determining that an audience user inputs a corresponding selection operation through the audience end, the audience end generates a corresponding command selection instruction according to the selection operation. The command selection instruction indicates one of a plurality of pre-stored command texts.

In response to determining that the audience end sends the corresponding command selection instruction, the command text indicated by the instruction is sent to the second electronic device, that is, the command text is sent to the audience end, so that the host end receives and displays the command text to the host user. After the host user reads the command text, even the information including semantics of the command text, he/she can make actions that match the command text and its semantics.

S2, an action video corresponding to the command text is received.

The action video is made by a user of the second electronic device, i.e., the host user, according to the command text and its semantics in response to determining that the second electronic device displays the command text and its semantics. The action video is used to match the command text and its semantics with a corresponding action.

In response to determining that the second electronic device collects and uploads the action video of the action made by the host user according to the command text and its semantics, the action video is received.

S3, a preset operation is performed in response to determining that the action video matches semantics of the command text.

That is, in response to determining that the action video matches the command text and its semantics, a predetermined operation, such as assigning corresponding rewards to the host user, is performed.

It can be seen from the above technical solutions that implementations of the application provide an information interaction method. The method is applied to a server in a webcast system. The server is used to, in response to a command selection instruction from a first electronic device persistently connected to the server, push a command text indicated by the command selection instruction to a second electronic device persistently connected to the server, such that the second electronic device displays the command text; receive an action video corresponding to semantics of the command text uploaded by the second electronic device; and if the action video matches semantics of the command text, perform a preset matching operation. Through the above operations, the method enables a user to perform preset operations, such as a reward operation, in different situations, which can enrich information interaction manners, attracting more users to participate, and improving the live streaming effect.

FIG. 2 is a flowchart showing another information interaction method according to an example implementation. This information interaction method includes following operations.

S1, a command text is pushed to a second electronic device according to a command selection instruction.

This operation is the same as the corresponding operation of the previous implementation, which will not be repeated herein.

S2, an action video corresponding to the command text is received.

This operation is the same as the corresponding operation of the previous implementation, which will not be repeated herein.

S21, information reflecting whether the action video matches semantics of the command text is received.

That is, after the second electronic device receives the action video, it detects whether the action video matches semantics of the command text, and sends the detection result to the third electronic device at the same time or after sending the action video. Correspondingly, after or at the same time the action video is received, the detection result is received, that is, information reflecting whether the action video matches the semantics of the command text is received.

S3, a preset operation is performed in response to determining that the action video matches semantics of the command text.

That is, in response to determining that the action video matches the command text and its semantics according to the received matching result, a predetermined operation, such as assigning corresponding rewards to the host user, is performed.

It can be seen from the above technical solutions that implementations of the application provide an information interaction method. The method is applied to a server in a webcast system. The server is used to, in response to a command selection instruction from a first electronic device persistently connected to the server, push a command text indicated by the command selection instruction to a second electronic device persistently connected to the server, such that the second electronic device displays the command text; receive an action video corresponding to the command text uploaded by the second electronic device; receive information reflecting whether the action video matches semantics of the command text; and in response to determining that the action video matches semantics of the command text, perform a preset matching operation. Through the above operations, the method enables a user to perform preset operations, such as a reward operation, in different situations, which can enrich information interaction manners, attracting more users to participate, and improving the live streaming effect.

FIG. 3 is a flowchart showing yet another information interaction method according to an example implementation. This information interaction method includes following operations.

S1, a command text is pushed to a second electronic device according to a command selection instruction.

This operation is the same as the corresponding operation of the previous implementation, which will not be repeated herein.

S2, an action video corresponding to semantics of the command text is received.

This operation is the same as the corresponding operation of the previous implementation, which will not be repeated herein.

S3, it is detected whether the action video matches semantics of the command text.

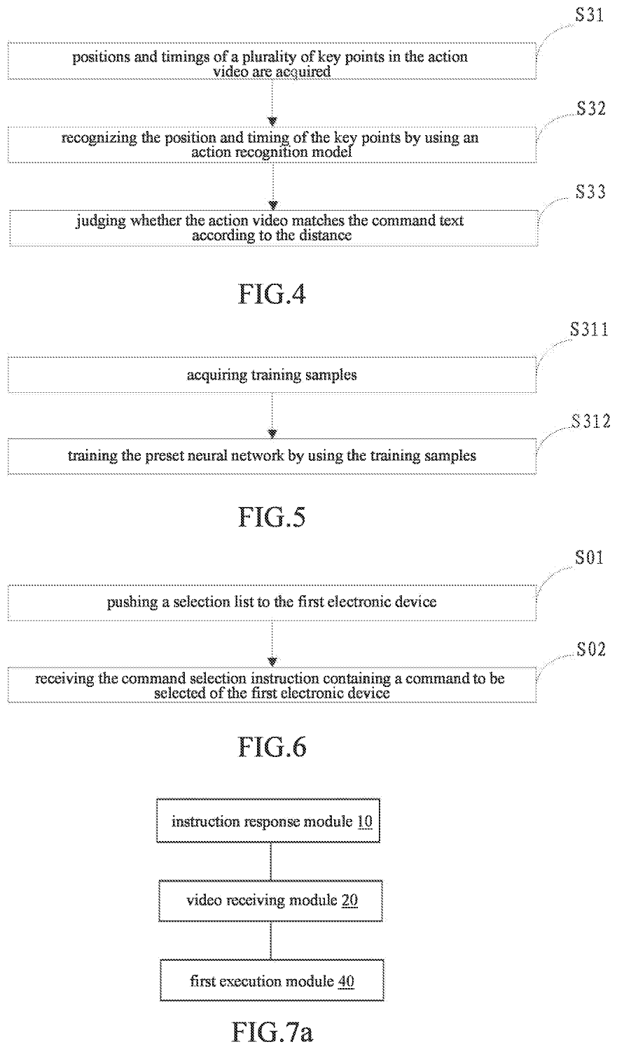

After the action video is received, it is detect whether the action video matches the command and its semantics by extracting the action features in the action video, that is, it is detected whether the action sequence can express the command text and its semantics. As shown in FIG. 4, the specific detection method is described as follows.

S31, positions and timings of a plurality of key points in the action video are acquired.

That is, target detection is performed on the action video, to determine positions and timings of a plurality of key points of the moving target, i.e., the host user's body. The key points can be selected from head, neck, elbows, hands, hips, knees and foot operations of the host user. Then the position and timing of each key point are determined. The timing can also be seen as a timing indicator of the position of each key point.

S32, the position and timing of the key points are recognized by using an action recognition model.

After the positions and timings of the plurality of key points are obtained, the corresponding positions and timings are input to a pre-trained action recognition model for recognition, to obtain a distance, such as Euclidean distance, between an action in the action video and a standard action corresponding to the command text in a preset standard library.

S33, it is judged whether the action video matches the command text according to the distance.

After the distance, such as Euclidean distance, is obtained, the distance is compared with a preset distance threshold. In response to determining that the distance is greater than or equal to the preset distance threshold, it is determined that the command text matches the action video; otherwise, it is determined that the command text does not match the action video. The preset distance threshold can be determined according to empirical parameters.

The following operations are also included herein, as shown in FIG. 5, for obtaining the action recognition model through training of a deep network.

S311, training samples are acquired.

The training samples herein include positive samples and negative samples. Positive samples refer to a plurality of key points corresponding to the preset command text, as well as the position and timing of each key point. The negative samples refer to positions and timings of a plurality of key points which do not conform to the command text.

S312, the preset neural network is trained by using the training samples.

During training, the training samples are input to the preset neural network for training. The neural network can be composed of Convolutional Neural Network (CNN) and Recurrent Neural Network (RNN). The loss function is for increasing the degree of discrimination, such as Contrastive Loss or triplet loss, which aims to make a distance, such as Euclidean distance, between a value (for example, a 1024-dimensional vector) output after the positive sample is input to the neural network and a value output after a standard action of the standard library is input to this neural network to be close, and make a distance between a value output after the negative sample is input to the neural network and a value output after a standard action of the standard library is input to this neural network to be not close.

S4, a preset operation is performed in response to determining that the action video matches semantics of the command text.

This operation is the same as the corresponding operation of the previous implementation, which will not be repeated herein.

It can be seen from the above technical solutions that implementations of the application provide an information interaction method. The method is applied to a server in a webcast system. The server is used to, in response to a command selection instruction from a first electronic device persistently connected to the server, push a command text indicated by the command selection instruction to a second electronic device persistently connected to the server, such that the second electronic device displays the command text; receive an action video corresponding to the command text uploaded by the second electronic device; detect whether the action video matches semantics of the command text; and in response to determining that the action video matches semantics of the command text, perform a preset matching operation. Through the above operations, the method enables a user to perform preset operations, such as a reward operation, in different situations, which can enrich information interaction manners, attracting more users to participate, and improving the live streaming effect.

In addition, as shown in FIG. 6, before pushing the command text to the second electronic device according to the command selection instruction in the implementation of the application, the following operations are further included.

S01, a selection list is pushed to the first electronic device.

That is, the selection list including items for the audience user to select is pushed to the first electronic device, so that the first electronic device displays the selection list. In response to determining that the audience user inputs the corresponding command selection instruction through the selection operation, a selection event is generated, and a command to be selected is selected according to the selection event.

S02, the command selection instruction containing a command to be selected of the first electronic device is received.

In response to determining that the first electronic device uploads the command selection instruction, the instruction is uploaded and the command to be selected included in the instruction is received.

In addition, before receiving a plurality of videos uploaded by the second electronic device in the implementation of the application, the method further includes performing the semantic analysis on the command text to obtain the semantics of the corresponding command text, so that the second electronic device can also display the semantics of the command text when displaying the command text, which can help the host user to understand the exact meaning of the command text.

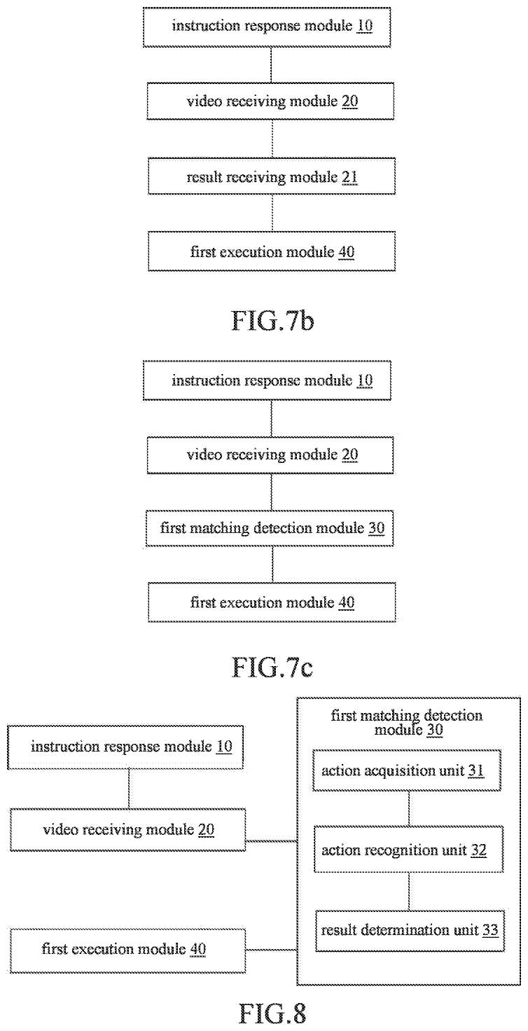

FIG. 7a is a block diagram showing an information interaction apparatus according to an example implementation. Such an information interaction apparatus is applied to a server of a webcast system and includes an instruction response module 10, a video receiving module 20, and a first execution module 40.

The instruction response module 10 is used to push a command text to a second electronic device according to a command selection instruction.

The command selection instruction is sent from a first electronic device corresponding to the second electronic device. As for the webcast system, the first electronic device can be understood as an audience end that is persistently connected with a server, and the second electronic device is a host end that is persistently connection with the server and corresponds to the audience end. In response to determining that an audience user inputs a corresponding selection operation through the audience end, the audience end generates a corresponding command selection instruction according to the selection operation. The command selection instruction indicates one of a plurality of pre-stored command texts.

In response to determining that the audience end sends the corresponding command selection instruction, the command text indicated by the instruction is sent to the second electronic device, that is, the command text is sent to the audience end, so that the host end receives and displays the command text to the host user. After the host user reads the command text, even the information including semantics of the command text, he/she can make actions that match the command text and its semantics.

The video receiving module 20 is used to receive an action video corresponding to semantics of the command text.

The action video is made by a user of the second electronic device, i.e., the host user, according to the command text and its semantics when the second electronic device displays the command text and its semantics. The action video is used to match the command text and its semantics with a corresponding action.

In response to determining that the second electronic device collects and uploads the action video of the action made by the host user according to the command text and its semantics, the action video is received.

The first execution module 40 is used to perform a preset operation in response to determining that the action video matches the command text.

That is, in response to determining that the action video matches the command text and its semantics, a predetermined operation, such as assigning corresponding rewards to the host user, is performed.

It can be seen from the above technical solutions that implementations of the application provide an information interaction apparatus. The apparatus is applied to a server in a webcast system. The server is used to, in response to a command selection instruction from a first electronic device persistently connected to the server, push a command text indicated by the command selection instruction to a second electronic device persistently connected to the server, such that the second electronic device displays the command text; receive an action video corresponding to the command text uploaded by the second electronic device; and if the action video matches semantics of the command text, perform a preset matching operation. Through the above operations, the method enables a user to perform preset operations, such as a reward operation, in different situations, which can enrich information interaction manners, attracting more users to participate, and improving the live streaming effect.

In addition, as shown in FIG. 7b, in a specific implementation of the application, a result receiving module 21 is further included.

After the second electronic device receives the action video, it detects whether the action video matches semantics of the command text, and sends the detection result to the third electronic device at the same time or after sending the action video. Correspondingly, the result receiving module receives the detection result, i.e., information reflecting whether the action video matches the semantics of the command text, after or at the same time receiving the action video, so that the first execution module has a clear basis for execution.

FIG. 7c is a block diagram showing yet another information interaction apparatus according to an example implementation. This information interaction apparatus is applied to a server of a webcast system, and includes an instruction response module 10, a video receiving module 20, a first matching detection module 30 and a first execution module 40.

The instruction response module 10 is used to push a command text to a second electronic device according to a command selection instruction.

The command selection instruction is sent from a first electronic device corresponding to the second electronic device. As for the webcast system, the first electronic device can be understood as an audience end that is persistently connected with a server, and the second electronic device is a host end that is persistently connection with the server and corresponds to the audience end. In response to determining that an audience user inputs a corresponding selection operation through the audience end, the audience end generates a corresponding command selection instruction according to the selection operation. The command selection instruction indicates one of a plurality of pre-stored command texts.

In response to determining that the audience end sends the corresponding command selection instruction, the command text indicated by the instruction is sent to the second electronic device, that is, the command text is sent to the audience end, so that the host end receives and displays the command text to the host user. After the host user reads the command text, even the information including semantics of the command text, he/she can make actions that match the command text and its semantics.

The video receiving module 20 is used to receive an action video corresponding to semantics of the command text.

The action video is made by a user of the second electronic device, i.e., the host user, according to the command text and its semantics in response to determining that the second electronic device displays the command text and its semantics. The action video is used to match the command text and its semantics with a corresponding action.

In response to determining that the second electronic device collects and uploads the action video of the action made by the host user according to the command text and its semantics, the action video is received.

The first matching detection module 30 is used to detect whether the action video matches the command text.

After the action video is received, it is detect whether the action video matches the command and its semantics by extracting the action features in the action video, that is, it is detected whether the action sequence can express the command text and its semantics. As shown in FIG. 8, the module includes an action acquisition unit 31, an action recognition unit 32 and a result determination unit 33.

The action acquisition unit 31 is used to acquire positions and timings of a plurality of key points in the action video.

That is, target detection is performed on the action video, to determine positions and timings of a plurality of key points of the moving target, i.e., the host user's body. The key points can be selected from head, neck, elbows, hands, hips, knees and foot operations of the host user. Then the position and timing of each key point are determined. The timing can also be seen as a timing indicator of the position of each key point.

The action recognition unit 32 is used to recognize the position and timing of the key points by using an action recognition model.

After the positions and timings of the plurality of key points are obtained, the corresponding positions and timings are input to a pre-trained action recognition model for recognition, to obtain a distance, such as Euclidean distance, between an action in the action video and a standard action corresponding to the command text in a preset standard library.

The result determination unit 33 is used to determine whether the action video matches the command text according to the distance.

After the distance, such as Euclidean distance, is obtained, the distance is compared with a preset distance threshold. In response to determining that the distance is greater than or equal to the preset distance threshold, it is determined that the command text matches the action video; otherwise, it is determined that the command text does not match the action video. The preset distance threshold can be determined according to empirical parameters.

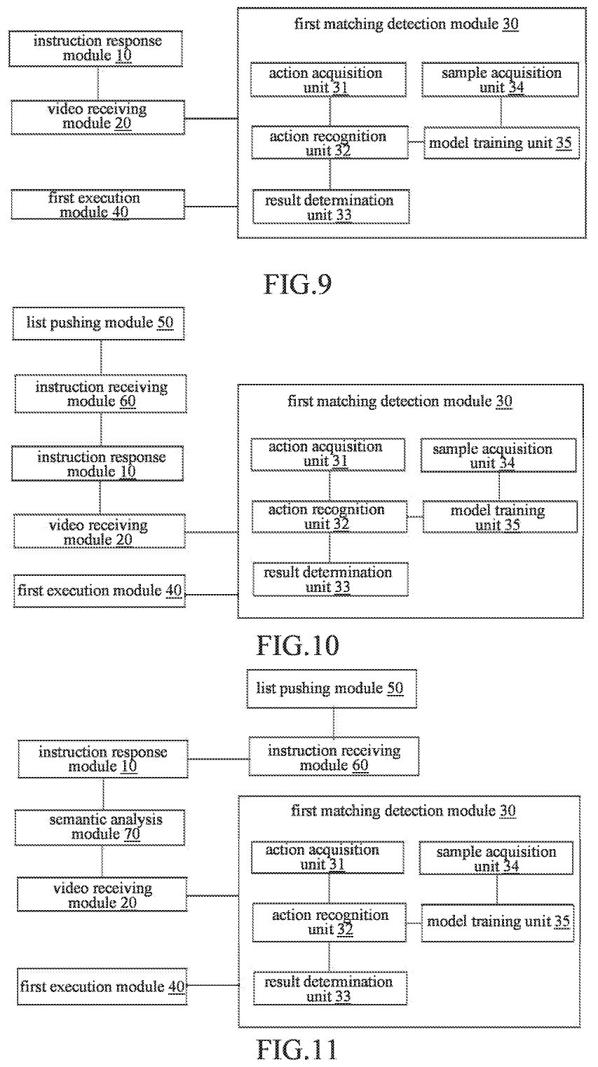

In addition, the module further includes a sample acquisition unit 34 and a model training unit 35, as shown in FIG. 9, for obtaining the action recognition model through training of a deep network.

The sample acquisition unit 34 is used to acquire training samples.

The training samples herein include positive samples and negative samples. Positive samples refer to a plurality of key points corresponding to the preset command text, as well as the position and timing of each key point. The negative samples refer to positions and timings of a plurality of key points which do not conform to the command text.

The model training unit 35 is used to train the preset neural network by using the training samples.

During training, the training samples are input to the preset neural network for training. The neural network can be composed of CNN and RNN. The loss function is for increasing the degree of discrimination, such as Contrastive Loss or triplet loss, which aims to make a distance, such as Euclidean distance, between a value (for example, a 1024-dimensional vector) output after the positive sample is input to the neural network and a value output after a standard action of the standard library is input to this neural network to be close, and make a distance between a value output after the negative sample is input to the neural network and a value output after a standard action of the standard library is input to this neural network to be not close.

The first execution module 40 is used to perform a preset operation in response to determining that the action video matches the command text.

That is, through the above judgment, in response to determining that the action video matches the command text and its semantics, a predetermined operation, such as assigning corresponding rewards to the host user, is performed.

It can be seen from the above technical solutions that implementations of the application provide an information interaction apparatus. The apparatus is applied to a server in a webcast system. The server is used to, in response to a command selection instruction from a first electronic device persistently connected to the server, push a command text indicated by the command selection instruction to a second electronic device persistently connected to the server, such that the second electronic device displays the command text; receive an action video corresponding to the command text uploaded by the second electronic device; detect whether the action video matches semantics of the command text; and in response to determining that the action video matches semantics of the command text, perform a preset matching operation. Through the above operations, the method enables a user to perform preset operations, such as a reward operation, in different situations, which can enrich information interaction manners, attracting more users to participate, and improving the live streaming effect.

In addition, as shown in FIG. 10, the information interaction apparatus in the implementation of the application further includes a list pushing module 50 and an instruction receiving module 60.

The list pushing module 50 is used to push a selection list to the first electronic device.

That is, the selection list including items for the audience user to select is pushed to the first electronic device, so that the first electronic device displays the selection list. In response to determining that the audience user inputs the corresponding command selection instruction through the selection operation, a selection event is generated, and a command to be selected is selected according to the selection event.

The instruction receiving module 60 is further used to receive the command selection instruction containing a command to be selected of the first electronic device.

In response to determining that the first electronic device uploads the command selection instruction, the instruction is uploaded and the command to be selected included in the instruction is received.

In addition, as shown in FIG. 11, the information interaction apparatus in the implementation of the application further includes a semantic analysis module 70, which is used for performing the semantic analysis on the command text to obtain the semantics of the corresponding command text, before the video receiving module 20 receives a plurality of videos uploaded by the second electronic device, so that the second electronic device can also display the semantics of the command text when displaying the command text, which helps the host user to understand the exact meaning of the command text.

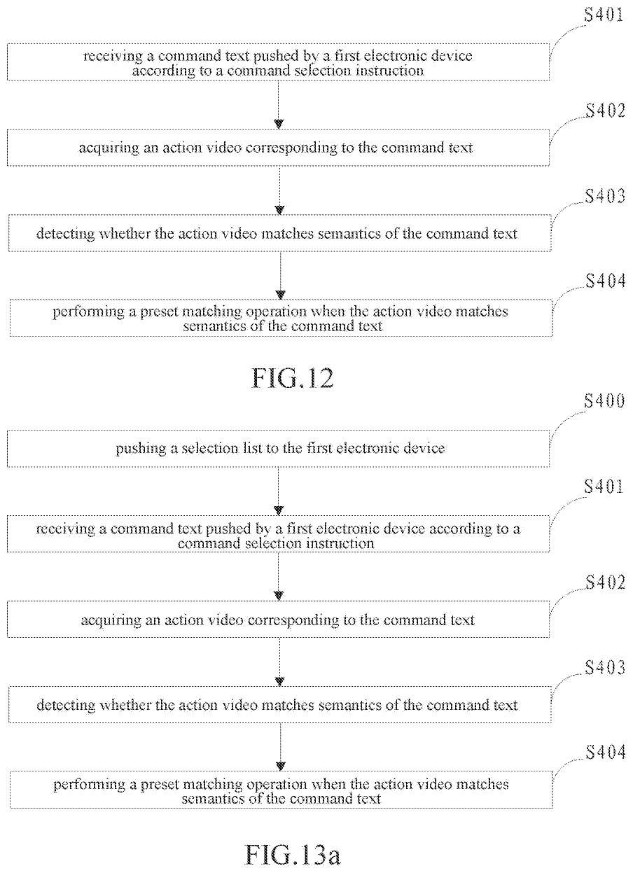

FIG. 12 is a flowchart showing yet another information interaction method according to an example implementation. The information interaction method provided in the implementation of the application is applied to a second electronic device directly or indirectly connected to a first electronic device. The first electronic device may be the audience end of the webcast system, and the second electronic device may be the host end of the webcast system. The information interaction method includes following operations.

S401, a command text pushed by a first electronic device according to a command selection instruction is received.

The command selection instruction is a command input by a user of the first electronic device, such as a user of an audience end, according to the content displayed by the first electronic device. After the user at the audience end enters the corresponding command selection instruction to select the corresponding command text, the first electronic device sends the command text out and receives the command text at this time.

Both the first electronic device and the second electronic device can be mobile terminals such as smart phones and tablet computers, and can also be understood as smart devices such as networked personal computers.

S402, an action video corresponding to the command text is acquired.

In some implementations, the video captured by a video capture device, such as a camera, which is set on the second electronic device or connected to the second electronic device is acquired. In some implementations, the action video made by the host user who uses the second electronic device according to the command text is required, such as making certain gestures or making a combination of a series of actions.

S403, it is detected whether the action video matches semantics of the command text.

That is, it is detected whether the action in the action video confirms to the semantics of the command text. For example, in response to determining that the command text is raising hands, it is detected whether the action in the action video is raising hands. If it is, the action video matches the semantics of the command text, otherwise it does not match. It is worth pointing out that the detection of whether the action video matches the semantics of the command text is performed at the host end. When there is a server, the information interacts with the first electronic device through the server or the information directly interacts with the first electronic device.

S404, a preset matching operation is performed in response to determining that the action video matches semantics of the command text.

The operation herein is the same as that in the above-mentioned implementation, which will not be repeated herein.

It can be seen from the above technical solutions that through the above operations, preset operations, such as rewards, can be performed on users in different situations, which can enrich the manners of information interaction, attracting more users to participate, and improving the live streaming effect.

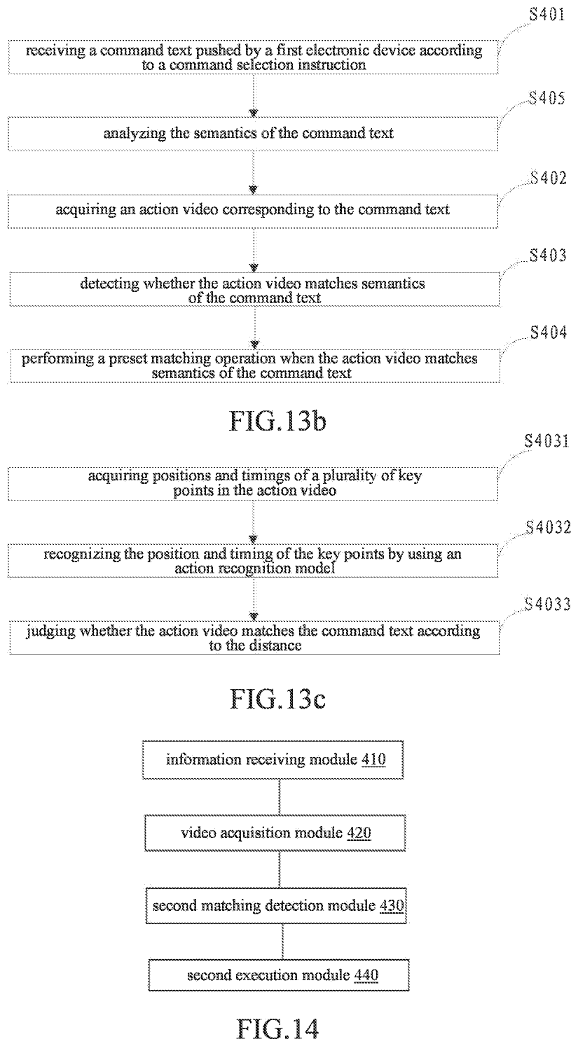

In addition, as shown in FIG. 13a, before receiving the command text pushed by the first electronic device in the implementation of the application, the method further includes:

S400, pushing a selection list to the first electronic device.

The selection list includes a plurality of commands to be selected for the user to select, respectively indicating different command texts, so that the user can select different command texts from the commands to be selected and send them to the second electronic device.

In addition, as shown in FIG. 13b, in this implementation of the application, after receiving the command text pushed by the first electronic device, the method further includes:

S405, analyzing the semantics of the command text.

By analyzing the semantics of the command text, the true semantics of the command text is obtained, so that there is an objective basis for detecting whether the action video matches the command text.

Also, as shown in FIG. 13c, detecting whether the action video matches the semantics of the command text in the implementation of the application includes following operations.

S4031, positions and timings of a plurality of key points in the action video are acquired.

That is, target detection is performed on the action video, to determine positions and timings of a plurality of key points of the moving target, i.e., the host user's body. The key points can be selected from head, neck, elbows, hands, hips, knees and foot operations of the host user. Then the position and timing of each key point are determined. The timing can also be seen as a timing indicator of the position of each key point.

S4032, the position and timing of the key points are recognized by using an action recognition model.

After the positions and timings of the plurality of key points are obtained, the corresponding positions and timings are input to a pre-trained action recognition model for recognition, to obtain a distance, such as Euclidean distance, between an action in the action video and a standard action corresponding to the command text in a preset standard library.

S4033, it is judged whether the action video matches the command text according to the distance.

After the distance, such as Euclidean distance, is obtained, the distance is compared with a preset distance threshold. In response to determining that the distance is greater than or equal to the preset distance threshold, it is determined that the command text matches the action video; otherwise, it is determined that the command text does not match the action video. The preset distance threshold can be determined according to empirical parameters.

FIG. 14 is a block diagram showing yet another information interaction apparatus according to an example implementation. The information interaction apparatus provided in an implementation of the application is applied to a second electronic device directly or indirectly connected to a first electronic device. The first electronic device may be regarded as the audience end of the webcast system, and the second electronic device may be regarded as the host end of the webcast system. The information interaction apparatus includes an information receiving module 410, a video acquisition module 420, a second matching detection module 430, and a second execution module 440.

The information receiving module is configured to receive a command text pushed by a first electronic device according to a command selection instruction.

The command selection instruction is a command input by a user of the first electronic device, such as a user of an audience end, according to the content displayed by the first electronic device. After the user at the audience end enters the corresponding command selection instruction to select the corresponding command text, the first electronic device sends the command text out and receives the command text at this time.

Both the first electronic device and the second electronic device can be mobile terminals such as smart phones and tablet computers, and can also be understood as smart devices such as networked personal computers.

The video acquisition module is configured to acquire an action video corresponding to the command text.

In some implementations, the video captured by a video capture device, such as a camera, which is set on the second electronic device or connected to the second electronic device is acquired. In some implementations, the action video made by the host user who uses the second electronic device according to the command text is required, such as making certain gestures or making a combination of a series of actions.

The second matching detection module is configured to detect whether the action video matches semantics of the command text.

That is, it is detected whether the action in the action video confirms to the semantics of the command text. For example, in response to determining that the command text is raising hands, it is detected whether the action in the action video is raising hands. If it is, the action video matches the semantics of the command text, otherwise it does not match.

The second execution module is configured to perform a preset matching operation in response to determining that the action video matches semantics of the command text.

The operation herein is the same as that in the above-mentioned implementation, which will not be repeated herein.

It can be seen from the above technical solutions that through the above operations, preset operations, such as rewards, can be performed on users in different situations, which can enrich the manners of information interaction, attracting more users to participate, and improving the live streaming effect.

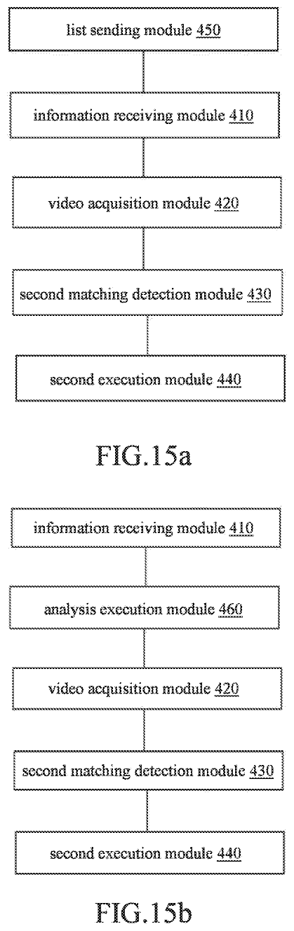

In addition, as shown in FIG. 15a, the implementation of the application further includes a list sending module 450.

The list sending module is configured to push a selection list to the first electronic device.

The selection list includes a plurality of commands to be selected for the user to select, respectively indicating different command texts, so that the user can select different command texts from the commands to be selected and send them to the second electronic device.

In addition, as shown in FIG. 15b, the implementation of the application further includes an analysis execution module 460.

The analysis execution module is used to analyze the semantics of the command text after the information receiving module receives the command text pushed by the first electronic device.

By analyzing the semantics of the command text, the true semantics of the command text is obtained, so that there is an objective basis for detecting whether the action video matches the command text.

In addition, the second matching detection module in the implementation of the application includes a parameter acquisition unit, a recognition execution unit and a judgment execution unit.

The parameter acquisition unit is used to acquire positions and timings of a plurality of key points in the action video.

That is, target detection is performed on the action video, to determine positions and timings of a plurality of key points of the moving target, i.e., the host user's body. The key points can be selected from head, neck, elbows, hands, hips, knees and foot operations of the host user. Then the position and timing of each key point are determined. The timing can also be seen as a timing indicator of the position of each key point.

The recognition execution unit is used to recognize the position and timing of key points by using an action recognition model.

After the positions and timings of the plurality of key points are obtained, the corresponding positions and timings are input to a pre-trained action recognition model for recognition, to obtain a distance, such as Euclidean distance, between an action in the action video and a standard action corresponding to the command text in a preset standard library.

The judgment execution unit is used to judge whether the action video matches the command text according to the distance.

After the distance, such as Euclidean distance, is obtained, the distance is compared with a preset distance threshold. In response to determining that the distance is greater than or equal to the preset distance threshold, it is determined that the command text matches the action video; otherwise, it is determined that the command text does not match the action video. The preset distance threshold can be determined according to empirical parameters.

An implementation of the application also provides a computer program, which is used to execute the information interaction method described in FIG. 1 to 6, 12, 13a, 13b, or 13c.

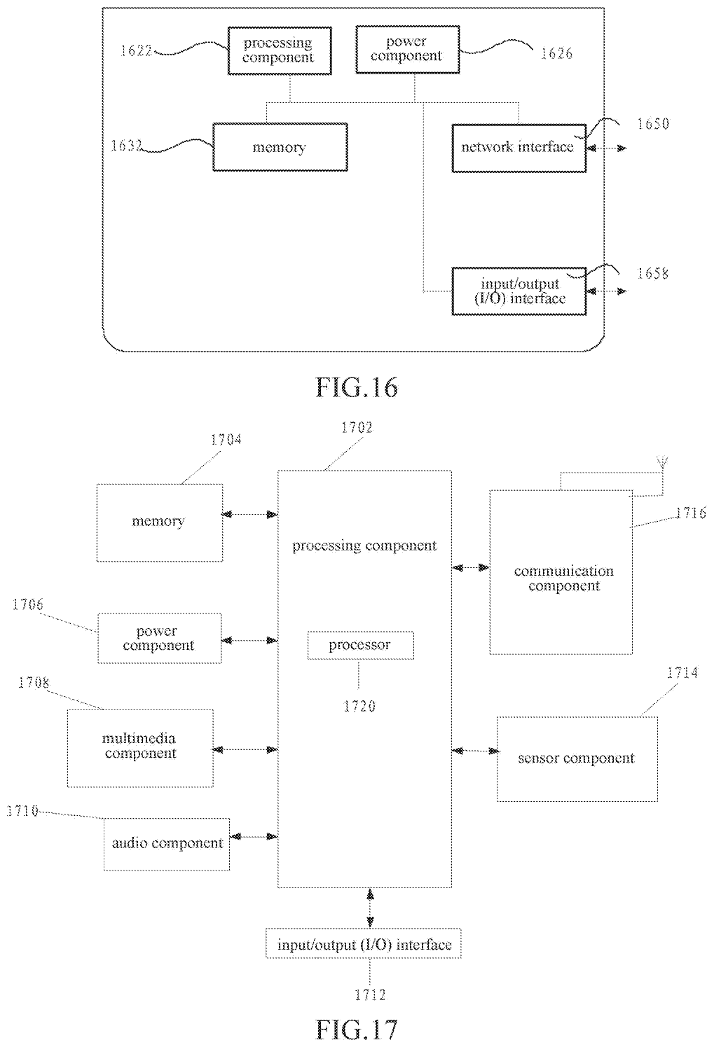

FIG. 16 is a block diagram showing an electronic device according to an example implementation. For example, the electronic device can be provided as a server. Referring to FIG. 16, the electronic device includes a processing component 1622, which further includes one or more processors, and a memory resource represented by a memory 1632, for storing instructions executable by the processing component 1622, such as application programs. The application program stored in the memory 1632 may include one or more modules each corresponding to a set of instructions. In addition, the processing component 1622 is configured to execute the information interaction method shown in FIG. 1 to 6, 12, 13a, 13b, or 13c.

The electronic device may further include a power component 1626 configured to perform power management of the electronic device, a wired or wireless network interface 1650 configured to connect the electronic device to the network, and an input/output (I/O) interface 1658. The electronic device can operate an operating system stored in the memory 1632, such as Windows Server™, Mac OS X™, Unix™, Linux™, FreeBSD™ or the like.

FIG. 17 is a block diagram showing another electronic device according to an example implementation. For example, the electronic device may be a mobile device such as a mobile phone, a computer, a digital broadcasting terminal, a messaging device, a game console, a tablet device, a medical device, a fitness device, and a personal digital assistant or the like.

Referring to FIG. 17, the electronic device may include one or more of the following components: a processing component 1702, a memory 1704, a power component 1706, a multimedia component 1708, an audio component 1710, an input/output (I/O) interface 1712, a sensor component 1714, and a communication component 1716.

The processing component 1702 typically controls the overall operations of the electronic device, such as the operations associated with display, telephone calls, data communications, camera operations, and recording operations. The processing component 1702 can include one or more processors 1720 to execute instructions to perform all or part of the operations in the above described methods. Moreover, the processing component 1702 can include one or more modules to facilitate the interaction between the processing component 1702 and other components. For example, the processing component 1702 can include a multimedia module to facilitate the interaction between the multimedia component 1708 and the processing component 1702.

The memory 1704 is configured to store various types of data to support the operation of the electronic device. Examples of such data include instructions for any application or method operated on the electronic device, such as the contact data, the phone book data, messages, pictures, videos, and the like. The memory 1704 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1706 provides power to various components of the electronic device. The power component 1706 can include a power management system, one or more power sources, and other components associated with the generation, management, and distribution of power in the electronic device.

The multimedia component 1708 includes a screen providing an output interface between the electronic device and the user. In some implementations, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some implementations, the multimedia component 1708 includes a front camera and/or a rear camera. When the electronic device is in an operation mode, such as a photographing mode or a video mode, the front camera and/or the rear camera can receive external multimedia data. Each of the front camera and the rear camera may be a fixed optical lens system or have focus and optical zoom capability.

The audio component 1710 is configured to output and/or input an audio signal. For example, the audio component 1710 includes a microphone (MIC) configured to receive an external audio signal when the electronic device is in an operation mode, such as a call mode, a recording mode, and a voice recognition mode. The received audio signal may be further stored in the memory 1704 or sent via the communication component 1716. In some implementations, the audio component 1710 also includes a speaker for outputting the audio signal.

The I/O interface 1712 provides an interface between the processing component 1702 and peripheral interface modules, such as a keyboard, a click wheel, buttons, and the like. These buttons may include, but not limited to, a home button, a volume button, a starting button, and a locking button.

The sensor component 1714 includes one or more sensors for providing state assessments of various aspects of the electronic device. For example, the sensor component 1714 can detect an open/closed state of the electronic device, relative positioning of components, such as the display and the keypad of the electronic device. The sensor component 1714 can also detect a change in position of one component of the electronic device or the electronic device, the presence or absence of user contact with the electronic device, an orientation, or an acceleration/deceleration of the electronic device, and a change in temperature of the electronic device. The sensor component 1714 can also include a proximity sensor configured to detect the presence of nearby objects without any physical contact. The sensor component 1714 can also include a light sensor, such as a CMOS or CCD image sensor, configured to use in imaging applications. In some implementations, the sensor component 1714 can also include an accelerometer sensor, a gyroscope sensor, a magnetic sensor, a pressure sensor, or a temperature sensor.

The communication component 1716 is configured to facilitate wired or wireless communication between the electronic device and other devices. The electronic device can access a wireless network based on a communication standard, such as Wi-Fi, service providers (2G; 3G; 4G or 5G) or a combination thereof. In an example implementation, the communication component 1716 receives broadcast signals or broadcast associated information from an external broadcast management system via a broadcast channel. In an example implementation, the communication component 1716 also includes a near field communication (NFC) module to facilitate short-range communications.

In an example implementation, the electronic device may be implemented with one or more application specific integrated circuits (ASICs), digital signal processors (DSPs), digital signal processing devices (DSPDs), programmable logic devices (PLDs), field programmable Gate arrays (FPGAs), controllers, microcontrollers, microprocessors or other electronic components, to perform the information interaction method shown in FIG. 1 to 6, 12, 13a, 13b or 13c.

In an example implementation, there is also provided a non-transitory computer-readable storage medium including instructions, such as a memory 1704 including instructions executable by the processor 1720 of the electronic device to perform the above methods. For example, the non-transitory computer readable storage medium may be a ROM, a random access memory (RAM), a CD-ROM, a magnetic tape, a floppy disc, and an optical data storage device, or the like.

1. A method, comprising:
pushing a command text indicated by a command selection instruction to a second electronic device in response to the command selection instruction of a first electronic device, such that the second electronic device displays the command text;
receiving an action video corresponding to the command text uploaded by the second electronic device; and
performing a preset matching operation in response to determining that the action video matches semantics of the command text.

2. The method according to claim 1, further comprising:
pushing a selection list to the first electronic device, wherein the selection list comprises a plurality of commands to be selected;
receiving the command selection instruction containing a selected command uploaded by the first electronic device according to a selection event.

3. The method according to claim 1, after receiving an action video corresponding to the command text uploaded by the second electronic device, the method further comprising:
receiving information reflecting whether the action video matches semantics of the command text.

4. The method according to claim 1, after receiving an action video corresponding to the command text uploaded by the second electronic device, the method further comprising:
detecting whether the action video matches semantics of the command text.

5. The method according to claim 4, where said detecting whether the action video matches semantics of the command text comprises:
acquiring positions and timings of a plurality of key points of a moving target in the action video;
inputting the positions and timings of the plurality of key points to a pre-trained action recognition model for recognition, and obtaining a distance between an action in the action video and a standard action corresponding to the command text in a preset standard action library;
determining that the action video matches the semantics of the command text in response to determining that the distance reaches a preset standard.

6. The method according to claim 5, wherein the action recognition model is trained according to following operations:
acquiring a training sample, wherein the training sample comprises a plurality of preset commands and a plurality of key points corresponding to each preset command, and the position and timing corresponding to each key point;
training a preset neural network by using the training sample to obtain the action recognition model.

7. The method according to claim 6, wherein the training sample comprises a positive sample and a negative sample.

8. The method according to claim 1, before receiving an action video corresponding to the command text uploaded by the second electronic device, the method further comprising:
performing semantic analysis on the command text to obtain the semantics of the command text.

9-16. (canceled)

17. A method, comprising:
receiving and displaying a command text pushed by a first electronic device according to a command selection instruction;
acquiring an action video corresponding to the command text;
detecting whether the action video matches semantics of the command text; and
performing a preset matching operation in response to determining that the action video matches semantics of the command text.

18. The method according to claim 17, further comprising:
pushing a selection list to the first electronic device, wherein the selection list comprises a plurality of commands to be selected, such that the first electronic device uploads a command text corresponding to a selected command among the plurality of commands to be selected according to the command selection instruction.

19. The method according to claim 17, where said detecting whether the action video matches semantics of the command text comprises:
acquiring positions and timings of a plurality of key points of a moving target in the action video;
inputting the positions and timings of the plurality of key points to a pre-trained action recognition model for recognition, and obtaining a distance between an action in the action video and a standard action corresponding to the command text in a preset standard action library;
determining that the action video matches the semantics of the command text in response to determining that the distance reaches a preset standard.

20. The method according to claim 17, after receiving and displaying a command text pushed by a first electronic device according to a command selection instruction, the method further comprising:
performing semantic analysis on the command text to obtain the semantics of the command text.

21-24. (canceled)

25. An electronic device, applied to a webcast system, comprising:
a processor; and
a memory for storing instructions executable by the processor,
wherein the processor is configured to:
push a command text indicated by a command selection instruction to a second electronic device in response to the command selection instruction of a first electronic device, such that the second electronic device displays the command text;
receive an action video corresponding to the command text uploaded by the second electronic device; and
perform a preset matching operation in response to determining that the action video matches semantics of the command text.

26. The electronic device according to claim 25, wherein the processor is further configured to:
push a selection list to the first electronic device, wherein the selection list comprises a plurality of commands to be selected;
receive the command selection instruction containing a selected command uploaded by the first electronic device according to a selection event.

27. The electronic device according to claim 25, wherein the processor is further configured to:
receive information reflecting whether the action video matches semantics of the command text, after an action video corresponding to the command text uploaded by the second electronic device is received.

28. The electronic device according to claim 25, wherein the processor is further configured to:
detect whether the action video matches semantics of the command text, after an action video corresponding to the command text uploaded by the second electronic device is received.

29. The electronic device according to claim 28, wherein the processor is configured to:
acquire positions and timings of a plurality of key points of a moving target in the action video;
input the positions and timings of the plurality of key points to a pre-trained action recognition model for recognition, and obtain a distance between an action in the action video and a standard action corresponding to the command text in a preset standard action library;
determine that the action video matches the semantics of the command text in response to determining that the distance reaches a preset standard.

30. The electronic device according to claim 29, wherein the processor is configured to train the action recognition model according to following operations:
acquiring a training sample, wherein the training sample comprises a plurality of preset commands and a plurality of key points corresponding to each preset command, and the position and timing corresponding to each key point;
training a preset neural network by using the training sample to obtain the action recognition model.

31. The electronic device according to claim 30, wherein the training sample comprises a positive sample and a negative sample.

32. The electronic device according to claim 25, wherein the processor is further configured to:
perform semantic analysis on the command text to obtain the semantics of the command text, before an action video corresponding to the command text uploaded by the second electronic device is received.

33. An electronic device, applied to a webcast system, comprising:
a processor; and
a memory for storing instructions executable by the processor,
wherein the processor is configured to:
receive and display a command text pushed by a first electronic device according to a command selection instruction;
acquire an action video corresponding to the command text;
detect whether the action video matches semantics of the command text; and
perform a preset matching operation in response to determining that the action video matches semantics of the command text.

34. The electronic device according to claim 33, wherein the processor is further configured to:
push a selection list to the first electronic device, wherein the selection list comprises a plurality of commands to be selected, such that the first electronic device uploads a command text corresponding to a selected command among the plurality of commands to be selected according to the command selection instruction.

35. The electronic device according to claim 33, wherein the processor is configured to:
acquire positions and timings of a plurality of key points of a moving target in the action video;
input the positions and timings of the plurality of key points to a pre-trained action recognition model for recognition, and obtain a distance between an action in the action video and a standard action corresponding to the command text in a preset standard action library;
determine that the action video matches the semantics of the command text in response to determining that the distance reaches a preset standard.

36. The electronic device according to claim 33, wherein the processor is further configured to:
perform semantic analysis on the command text to obtain the semantics of the command text, after a command text pushed by a first electronic device according to a command selection instruction is received and displayed.

37. A non-transitory computer-readable storage medium, wherein
instructions in the storage medium, when executed by a processor of a mobile terminal, cause the mobile terminal to execute the information interaction method according to claim 1.

38. A non-transitory computer-readable storage medium, wherein instructions in the storage medium, when executed by a processor of a mobile terminal, cause the mobile terminal to execute the information interaction method according to claim 17.
